(19) United States
(12) Patent Application Publication
(10) Pub. No.: US 2004/0008508 A1
(43) Pub. Date: Jan. 15, 2004

(54) Door brite night light

(76) Inventor: Heather Lee Alvarez, Glenn, CA (US)

Correspondence Address: Heather Alvarez, 1523 Hwy 45, Glenn, CA, 95943, US

(21) Appl. No.: 10/194,905

(22) Filed: Jul. 15, 2002

(51) Int. Cl. E05B 17/10; F21L 4/02

(52) U.S. Cl. 362/100; 362/184; 362/200

(57) ABSTRACT

The Door Brite Night Light is a visual aid to assist one in locating a door handle in the darkness.

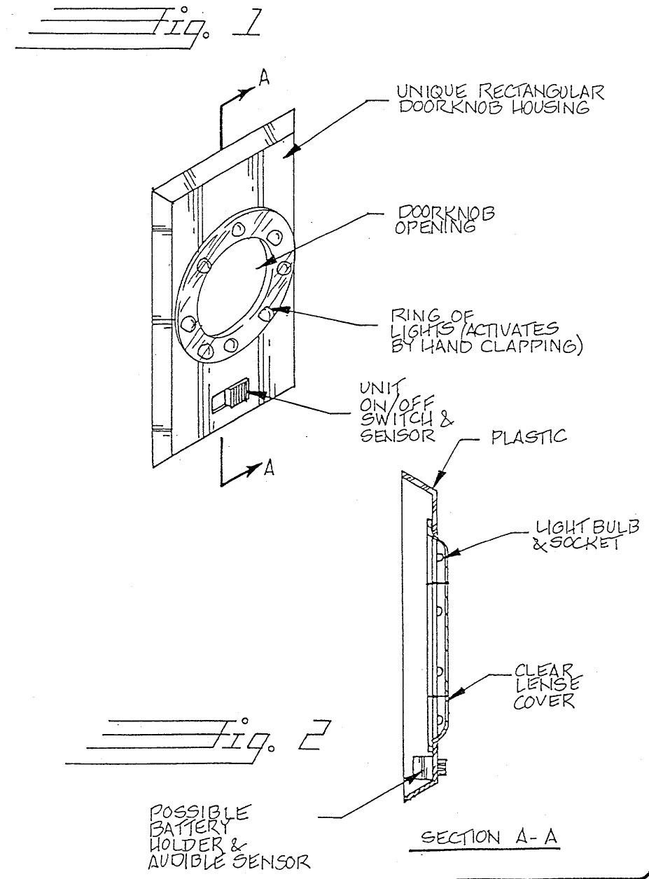

The Door Brite Night Light is a visual aid to assist one in the locating a door handle in the darkness. It is operated independently of household current which makes it ideal as a safety device in case of an emergency. Because the device is set around the handle of the door knob it dose not interfere with the operation of the door. The design of Door Brite Night Light calls for a rectangular injected molded plastic housing with a center circular opening that is designed to slip over the knob of traditional door handle, basically a night light that fits around the door handle. Encircling the exterior of the housing are tiny light bulbs that are powered by batteries housed with in the rear of the unit. Door Brite Night Light could also be maid into an electric device if manufactured to be. The unit has a switch located on the housing for the on/off position. This is done to conserve battery life when the unit is not in use. Once placed on the door, the circuit is turned on, however the lights are only activated on the Door Brite Night Light ny the noise of a persons hands hitting together. A pressure sensor designed to detect the unique frequency of the sound of the hand clap is equipped within the housing. When the unit is not in use, such as daylight hours or because the unit is portable, being moved from one location to another can be deactivated by placing the circuit switch in the off position. The Door Brite Night Light uses the same principle as the popular lamps and other household items designed for convenience of operation by battery power but are usually dependent upon household current. The Door Brite Night Light can be carried along while traveling, is easy to use and is harmless to the door panel on which it is placed. It should be noted however that the basic form and function of Door Brite Night Light may be varied or modified so that the application and use at Door Brite Night Light could be broader than originally envisioned.

### BACKGROUND OF INVENTION

The Door Brite Night Light is a visual aid to assist one in the locating a door handle in the darkness. It is operated independently of house hold current make it ideal as a safety device in case of an emergency. In an emergency situation it is imperative that one not lose any time locating an exit. Often in times of emergency the normal electricity to the home may be turned off, especially in times of storms when electrical lines are down. In case of fire, homeowners are aware that turning on the electrical lights could add even more danger to the home by producing a fire conduit. A new product Door Brite Night Light, is designed to operate independently of the household current enabling one to have visibility at the door knob of each door onto which it is used. Door Brite Night Light sets over the door knob of a door and is activated by the simple process of clapping of one's hands. The battery-operation of the unit makes it ideal to use at all times but because of its unique safety feature, especially desirable during emergences. Furthermore, while many young children cannot reach light switches to turn on the overhead lights they can easily be taught to clap their hands giving the child the necessary visibility to enter and exit a room in the dark. The market for the Door Brite Night Light would be all households as the device is useful for all age groups. Because of the problems that Door Brite Night Light addresses and solves thru its application, consumers will find such an invention attractive and appealing.

### INVENTION DESCRIPTION

The design of Door Brite Night Light calls for a rectangular injected molded plastic housing with a center circular opening that is designed to slip over the knob of a traditional door handle, basically a night light which fits around the door handle. Encircling the exterior of the housing are a series of sockets with tiny light bulbs that are powered by batteries housed within the rear of the unit. The unit has a switch located on the housing for the on/off position. This is done to conserve battery life when not in use. Once placed on the door, the circuit is turned on, however the lights are only activated on the Door Brite Night Light by the sound of ones hands clapping. A pressure sensor designed to detect the unique frequency of the hand clap is equipped within the housing.

### REFERENCE TO SEQUENCE LISTING

Door Brite Night Light is to be made out of plastics and electrical components. Material which could be considered to create a durable housing for Door Brite Night Light is ABS (Acrylonitrile-Butadiene-Styrene). ABS is a molded plastic manufactured by Borg-Warner Chemicals and characterized by high rigidity and impact strength, excellent abrasion, heat,cold,and moisture resistant. Fortunately, the production technology would vary little from that currently utilized in the production of similar products. Materials, processes, and even construction would be similar with adaptions made specific design of Door Brite Night Light. The components of Door Brite Night Light utilize standard production technology. It is my present conclusion that this product can be manufactured from conventional and commercially available materials with existing production technology. As for the final size(assuming the manufacture dose not create multiple sizes), grade of materials used and performance standards for each component, these determinations would depend on the results of both further testing and research.

1. The light that go's around the door handle that is a visual aid to assist in locating a door handle in the darkness, is operated independently of household current making it a safety device in case of an emergency.
